(19) United States
(12) Patent Application Publication
(10) Pub. No.: US 2025/0136771 A1
(43) Pub. Date: May 1, 2025

(54) PROTECTIVE FILM, DISPLAY DEVICE INCLUDING THE SAME, AND METHOD OF MANUFACTURING THE PROTECTIVE FILM

(71) Applicant: Samsung Display Co., Ltd., Yongin-Si (KR)

(72) Inventor: Jonghwan Cho, Yongin-si (KR)

(21) Appl. No.: 18/779,087

(22) Filed: Jul. 22, 2024

(30) Foreign Application Priority Data
Oct. 25, 2023 (KR) 10-2023-0144169

(51) Int. Cl. C08J 5/18; B05D 1/00; B05D 1/38

(52) U.S. Cl. CPC C08J 5/18; B05D 1/38; B05D 1/60; B05D 2508/00; C08J 2385/00

(57) ABSTRACT

A protective film having low reflectance and improved resistant to cracks is disclosed, along with a display device including the protective film and a method of manufacturing the protective film. The protective film includes a base layer, a hard coating layer disposed on the base layer, and a low refractive layer disposed on the hard coating layer and containing dodecafluoroheptyl acrylate (DFHA).

### CROSS-REFERENCE TO RELATED APPLICATION

This application is based on and claims priority, under 35 U.S.C. § 119, to Korean Patent Application No. 10-2023-0144169 filed on Oct. 25, 2023 in the Korean Intellectual Property Office, the disclosure of which is incorporated by reference herein in its entirety.

### BACKGROUND

### 1. Field

The disclosure relates to a protective film, a display device including the same, and a method of manufacturing the protective film. More particularly, the disclosure relates to a protective film having low reflectance and being resistant to cracks, a display device including the same, and a method of manufacturing the protective film.

### 2. Description of the Related Art

Display devices display an image by receiving information about the image. Display devices are used as display parts of compact products such as mobile phones, or as display parts for large products such as televisions.

A display device includes a plurality of pixels that emit light by receiving an electrical signal to display an image to the outside. Each pixel includes a light-emitting element, and for an organic light-emitting display device, an organic light-emitting diode is included as the light-emitting element. In a general organic light-emitting display device, thin film transistors and organic light-emitting diodes are formed on a substrate, and the organic light-emitting diodes emit light.

Such a display device is vulnerable to external impacts, and thus, the display device may include a protective film for protecting a display surface from external impacts. However, when a protective film is attached to a flexible display device, cracks may occur in the protective film in a folding area.

### SUMMARY

One or more embodiments include a protective film having low reflectance and being resistant to cracks, a display device including the same, and a method of manufacturing the protective film. However, such an objective is an example, and the scope of the disclosure is not limited thereby.

Additional aspects will be set forth in part in the description which follows and, in part, will be apparent from the description, or may be learned by practice of the presented embodiments of the disclosure.

According to one or more embodiments, a protective film includes a base layer, a hard coating layer disposed on the base layer, and a low refractive layer disposed on the hard coating layer and including dodecafluoroheptyl acrylate (DFHA).

In an embodiment, the low refractive layer includes a polymer compound consisting of the DFHA, a degree of polymerization of the polymer compound may be any one of 6, 8, 10, and 12.

In an embodiment, the low refractive layer includes a polymer compound consisting of the DFHA, a degree of polymerization of the polymer compound may be 8.

In an embodiment, the low refractive layer may include the DFHA only.

In an embodiment, the thickness of the low refractive layer may be about 70 nm to about 130 nm.

In an embodiment, the fluorine content of the low refractive layer may be about 45 wt % to about 80 wt %.

In an embodiment, the infrared spectrum of the low refractive layer may include two —CF₂ peaks and one —CF₃ peak.

In an embodiment, the —CF₂ peaks may include a first peak frequency in a range of about 1150 cm⁻¹ to about 1160 cm⁻¹ and a second peak frequency in a range of about 1210 cm⁻¹ to about 1220 cm⁻¹.

In an embodiment, the —CF₃ peak may have three peak frequencies in a range of about 975 cm⁻¹ to about 1280 cm⁻¹.

According to one or more embodiments, a display device includes a display module foldable with respect to at least one folding axis, and a protective film disposed on the display module, wherein the protective film includes a base layer, a hard coating layer disposed on the base layer, and a low refractive layer disposed on the first coating layer and including DFHA.

In an embodiment, the low refractive layer includes a polymer compound consisting of the DFHA, a degree of polymerization of the polymer compound may be any one of 6, 8, 10, and 12.

In an embodiment, the low refractive layer includes a polymer compound consisting of the DFHA, a degree of polymerization of the polymer compound may be 8.

In an embodiment, the low refractive layer may include the DFHA only.

In an embodiment, the thickness of the low refractive layer may be about 70 nm to about 130 nm.

In an embodiment, the fluorine content of the low refractive layer may be about 45 wt % to about 80 wt %.

In an embodiment, the infrared spectrum of the low refractive layer may include two —CF₂ peaks and one —CF₃ peak.

In an embodiment, the —CF₂ peaks may include a first peak frequency in a range of about 1150 cm⁻¹ to about 1160 cm⁻¹ and a second peak frequency in a range of about 1210 cm⁻¹ to about 1220 cm⁻¹.

In an embodiment, the —CF₃ peak may have three peak frequencies in a range of about 975 cm⁻¹ to about 1280 cm⁻¹.

According to one or more embodiments, a method of manufacturing a protective film includes forming a base layer on a substrate, forming a hard coating layer on the base layer, and performing a vacuum deposition polymerization process of forming a low refractive layer including DFHA on the hard coating layer.

In an embodiment, the method may further include performing an ultraviolet (UV) ozone processing process on the upper surface of the hard coating layer before the performing of the vacuum deposition polymerization process.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic plan view of a display panel of a display device according to an embodiment;

FIG. 2 is a schematic perspective view of a folding state of the display device of FIG. 1;

FIG. 3 is a schematic perspective view of a display panel of a display device according to another embodiment;

FIG. 4 is a schematic cross-sectional view of a pixel taken along line I-I′ of FIG. 1;

FIG. 5 is a schematic exploded perspective view of a display module, a cover member, and a protective film of the display device of FIG. 1;

FIG. 6 is a conceptual view schematically illustrating a stack structure of the protective film of FIG. 5;

FIG. 7 is a graph showing result data of performing RAS-IR analysis on a low refractive layer of FIG. 6;

FIG. 8 is a flowchart schematically showing a method of manufacturing the protective film, according to an embodiment; and

FIG. 9 is a conceptual diagram of a process used in the manufacturing method of FIG. 8.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

Various modifications may be applied to the present embodiments, and particular embodiments will be illustrated in the drawings and described in the detailed description section. The effect and features of the present embodiments, and a method to achieve the same, will be clearer referring to the detailed descriptions below with the drawings. However, the present embodiments may be implemented in various forms, not by being limited to the embodiments presented below.

Hereinafter, embodiments will be described in detail with reference to the accompanying drawings, and in the description with reference to the drawings, the same or corresponding constituents are indicated by the same reference numerals and redundant descriptions thereof are omitted.

In the following embodiment, it will be understood that although the terms first, second, etc. may be used herein to describe various elements, these elements should not be limited to a specific order by these terms. These elements are only used to distinguish one element from another. Furthermore, in the following embodiment, as used herein, the singular forms “a,” “an,” and “the” are intended to include the plural forms as well, unless the context clearly indicates otherwise.

It will be understood that when a component, such as a layer, a film, a region, or a plate, is referred to as being “on” another component, the component can be directly on the other component or intervening components may be present thereon.

Sizes of components in the drawings may be exaggerated for convenience of explanation. For example, since sizes and thicknesses of elements in the drawings are arbitrarily illustrated for convenience of explanation, the following embodiments are not limited thereto.

In the following embodiment, it will be further understood that the terms “comprises” and/or “comprising” used herein specify the presence of stated features or elements, but do not preclude the presence or addition of one or more other features or components.

In the following embodiment, it will be understood that when an element, such as a layer, a film, a region, or a plate, is referred to as being “on” another element, the element can be directly on the other element or intervening elements may be present thereon.

When a certain embodiment may be implemented differently, a specific process order may be performed differently from the described order. For example, two consecutively described processes may be performed substantially at the same time or performed in an order opposite to the described order.

In the specification, the expression such as “A and/or B” may include A, B, or A and B. The expression such as “at least one of A and B” may include A, B, or A and B.

In the following embodiment, it will be understood that when a layer, region, or element is referred to as being “connected to” another layer, region, or element, it can be directly connected to the other layer, region, or component or indirectly connected to the other layer, region, or component via intervening layers, regions, or components. For example, in the specification, when a layer, region, or component is referred to as being electrically connected to another layer, region, or component, it can be directly electrically connected to the other layer, region, or component or indirectly electrically connected to the other layer, region, or component via intervening layers, regions, or components.

In the following embodiment, an x-axis, a y-axis, and a z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

Hereinafter, a protective film, a display device including the same, and a method of manufacturing the protective film, according to an embodiment based on contents described above are described in detail as follows.

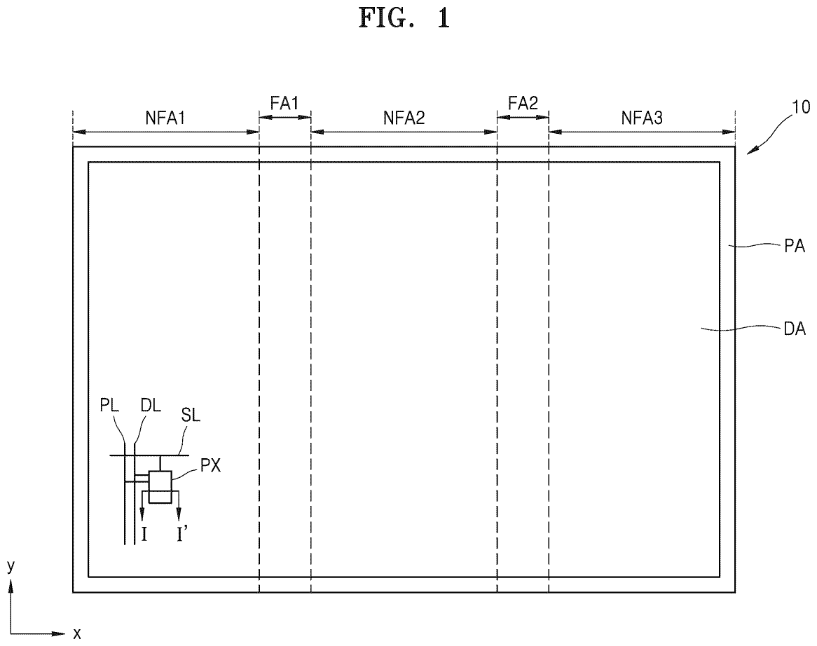

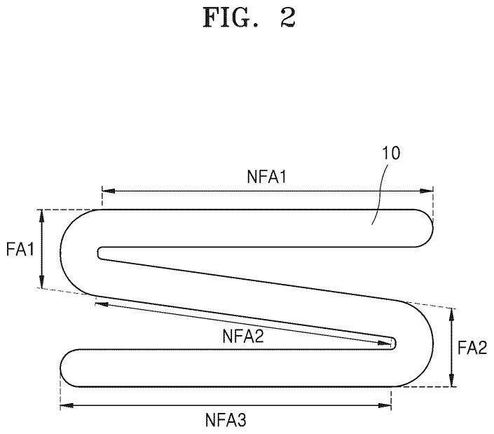

FIG. 1 is a schematic plan view of a display panel 10 of a display device according to an embodiment, and FIG. 2 is a schematic perspective view of a folding state of the display device of FIG. 1.

As illustrated in FIG. 1, a display device according to an embodiment may include a display panel 10. Such a display device may be any device including the display panel 10. For example, a display device may include various devices, such as smartphones, tablets, laptops, televisions, billboards, or the like. The display device according to an embodiment may include thin film transistors, capacitors, and the like, which may be implemented by conductive layers and insulating layers.

As illustrated in FIG. 1, the display panel 10 may include a display area DA and a peripheral area PA located outside the display area DA. In FIG. 1, the display area DA is illustrated as having a rectangular shape. However, the disclosure is not limited thereto. The display area DA may have various shapes, for example, a circle, an oval, a polygon, a specific figure, and the like.

The display area DA is a portion for displaying an image, and a plurality of pixels PX may be arranged therein. Each pixel PX may include a display element such as an organic light-emitting diode. Each pixel PX may emit, for example, red, green, or blue light. The pixel PX may be connected to a pixel circuit including thin film transistors (TFT), a storage capacitor, and the like. The pixel circuit may be connected to a scan line SL for transmitting a scan signal, a data line DL crossing the scan line SL and transmitting a data signal, a driving voltage line PL for supplying a driving voltage and the like. The scan line SL may extend in an x direction (hereinafter, referred to as “second direction”), and the data line DL and the driving voltage line PL may extend in a y direction (hereinafter, referred to as “first direction”).

The pixel PX may emit light with a luminance corresponding to an electrical signal from the pixel circuit to which the pixel PX is electrically connected. The display area DA may display a certain image through the light emitted from the pixel PX. For reference, the pixel PX may be defined as an emission area that emits any one of red, green, and blue light, as described above.

The peripheral area PA, which is an area where the pixel PX is not arranged, may be an area that does not display an image. A power supply wire for driving the pixel PX may be located in the peripheral area PA. Furthermore, a plurality of pads may be arranged in the peripheral area PA, and a printed circuit board including a driving circuit portion or an integrated circuit element such as a driver IC may be arranged to be electrically connected to the pads.

For reference, as the display panel 10 includes a substrate 100, it may be said that the substrate 100 includes the display area DA and the peripheral area PA. The substrate 100 will be described below in detail.

Furthermore, a plurality of transistors may be arranged in the display area DA. In the transistors, a first terminal of a transistor may be a source electrode or a drain electrode, and a second terminal thereof may be an electrode different from the first terminal, depending on the type of a transistor (N-type or P-type) and/or operation conditions thereof. For example, when the first terminal is a source electrode, the second terminal may be a drain electrode.

The transistors may include a driving transistor, a data write transistor, a compensation transistor, an initialization transistor, an emission control transistor, and the like. The driving transistor may be connected between the driving voltage line PL and the organic light-emitting diode, and the data write transistor may be connected between the data line DL and the driving transistor and may perform a switching operation of transmitting a data signal transmitted through the data line DL.

The compensation transistor may be turned on in response to the scan signal received through the scan line SL to connect the driving transistor to the organic light-emitting diode, thereby compensating for a threshold voltage of the driving transistor.

The initialization transistor may be turned on in response to the scan signal received through the scan line SL to transmit an initialization voltage to a gate electrode of the driving transistor, thereby initializing the gate electrode of the driving transistor. The scan line connected to the initialization transistor may be a scan line different from the scan line connected to the compensation transistor.

The emission control transistor may be turned on in response to an emission control signal received through an emission control line, and as a result, a driving current may flow in the organic light-emitting diode.

The organic light-emitting diode may include a pixel electrode (anode) and a counter electrode (cathode), and a counter electrode (cathode) may receive a second power voltage (ELVSS). The organic light-emitting diode may display an image by receiving the driving current from the driving transistor and emitting light.

As illustrated in FIGS. 1 and 2, the display panel 10 according to an embodiment may include at least one folding area FAi and a plurality of non-folding areas NFAj, wherein “i” and “j” are integers. For example, the display panel 10 may include a first folding area FA1 and a second folding area FA2, and the display panel 10 may also include a first non-folding area NFA1, a second non-folding area NFA2, and a third non-folding area NFA3.

For example, the first folding area FA1, as a portion of the display panel 10, may be bent or folded with respect to a first folding axis. The first folding axis may be a virtual axis extending in a y-axis direction. The first folding area FA1 may have a folding state and a non-folding state. The folding state may refer to a state in which the first folding area FA1 is folded with respect to the first folding axis, and the non-folding state may refer to a state in which the first folding area FA1 is not folded and is flat.

For example, the second folding area FA2, as a portion of the display panel 10, may be bent or folded with respect to a second folding axis. The second folding axis, as a virtual axis extending in the y-axis direction, may be parallel to the first folding axis and spaced apart from the first folding axis. The second folding area FA2 may have a folding state and a non-folding state. The folding state may refer to a state in which the second folding area FA2 is folded with respect to the second folding axis, and the non-folding state may refer to a state in which the second folding area FA2 is flat, not folded.

For example, the first folding area FA1 in a non-folding state may be arranged between the first non-folding area NFA1 and the second non-folding area NFA2. The second folding area FA2 in a non-folding state may be arranged between the second non-folding area NFA2 and the third non-folding area NFA3. The second non-folding area NFA2 in a non-folding state may be arranged between the first folding area FA1 and the second folding area FA2.

For example, the first folding area FA1 folds in a different (e.g., opposite) direction from the second folding area FA2. For example, when the first folding area FA1 is in a folded state, the back side of the first non-folding area NFA1 and the back side of the second non-folding may face each other. When the second folding area FA2 is in a folding state, the front side of the second non-folding area NFA2 and the front side of the third non-folding area NFA3 may face each other.

However, the direction in which the first folding area FA1 is folded and the direction in which the second folding area FA2 is folded, as described above, are merely example. In addition to or instead of the example depicted in FIG. 2, the display panel 10 may be folded in various directions.

In the following description, an organic light-emitting display device is described as an example of the display device according to an embodiment, the display device according to an embodiment is not limited thereto. In another embodiment, the display device according to an embodiment may include a display device, such as an inorganic light-emitting display device (or an inorganic EL display device), or a quantum-dot light-emitting display device. For example, an emission layer of the display element in the display device may include an organic material or an inorganic material. Furthermore, the display device may include the emission layer and quantum dots located in a path of light emitted from the emission layer.

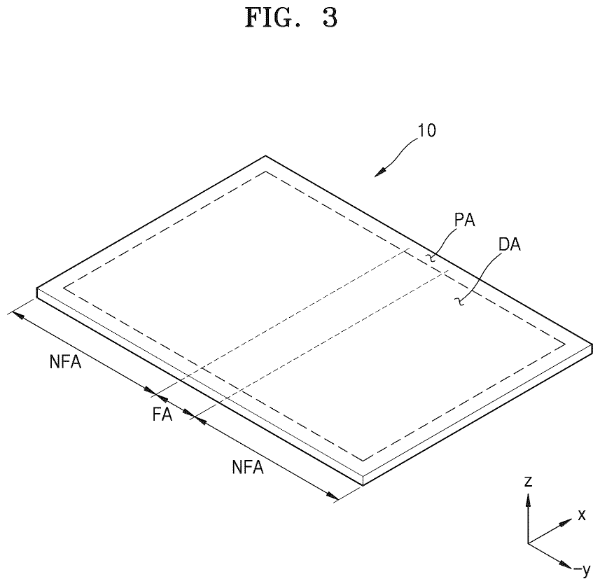

FIG. 3 is a schematic perspective view of a display panel 10 of a display device according to another embodiment.

For reference, the same or redundant descriptions between FIG. 3 and FIGS. 1 and 2 described above may be omitted.

As illustrated in FIG. 3, the display panel 10 of a display device according to the present embodiment may include the display area DA and the peripheral area PA as in the display panel 10 of FIGS. 1 and 2.

The display panel 10 may include one folding area and non-folding areas extending from opposite sides of the one folding area. For example, in a non-folding state, the folding area may be arranged between the non-folding areas. Although not explicitly shown in the figure, when the folding area is in a “folded state,” the front sides of the non-folding areas may face each other, or the back sides of the non-folding areas may face each other.

Although not explicitly shown, the display area DA of FIG. 3 may include the pixel structure and the same pixel structure of FIG. 1, and for convenience, the illustration and description of the pixel structure of FIG. 1 presented above are used for the illustration and description of the pixel structure of FIG. 3.

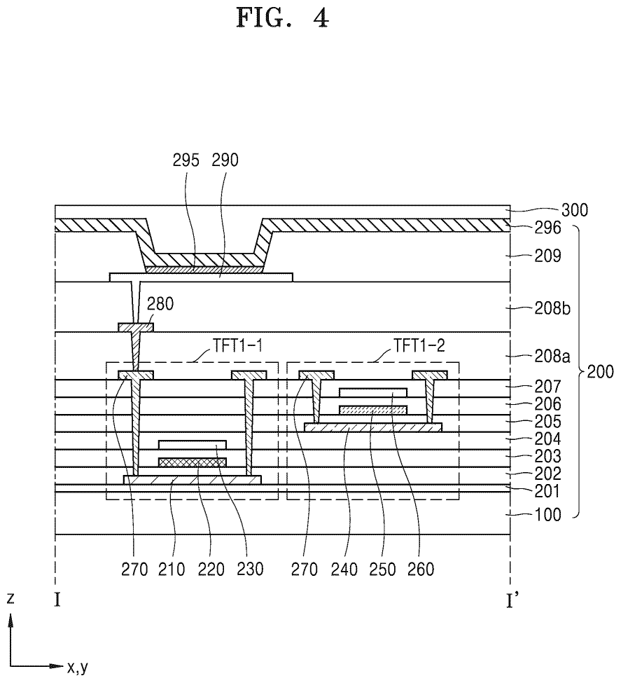

FIG. 4 is a schematic cross-sectional view of a pixel taken along line I-I′ of FIG. 1.

For reference, the same or redundant descriptions between FIG. 4 and FIGS. 1 to 3 described above may be omitted.

The substrate 100 of FIG. 4 may be the substrate 100 of FIG. 1. The substrate 100 may include the area corresponding to the display area DA and the peripheral area PA outside the display area DA, as described above. The substrate 100 may include various materials with flexible or bendable characteristics. For example, the substrate 100 may include glass, metal, or polymer resin. Furthermore, the substrate 100 may include polymer resin, such as polyethersulfone, polyacrylate, polyetherimide, polyethylene naphthalate, polyethylene terephthalate, polyphenylene sulfide, polyarylate, polyimide, polycarbonate, or cellulose acetate propionate polymer resin. The substrate 100 may be variously modified, for example, to have a multilayer structure including two layers each including polymer resin as above and a barrier layer including an inorganic material (a silicon oxide, a silicon nitride, a silicon oxynitride, etc.) provided between the layers.

A buffer layer 201 may be disposed on the substrate 100. The buffer layer 201 may prevent diffusion of impurity ions, prevent infiltration of moisture or external air, and serve as a barrier layer for surface planarization, and/or a blocking layer. The buffer layer 201 may include a silicon oxide, a silicon nitride, or a silicon oxynitride. Furthermore, the buffer layer 201 may adjust a heat supply speed during a crystallization process for forming a first semiconductor layer 210, so that the first semiconductor layer 210 is uniformly crystallized.

The first semiconductor layer 210 may be disposed on the buffer layer 201. The first semiconductor layer 210 may include polysilicon, and may include a channel region, in which impurities are not doped, and a source region and a drain region arranged at opposite sides of the channel region, and in which impurities are doped. The impurities differ from each other depending on the type of a thin film transistor, and may include N-type impurities or P-type impurities.

A first gate insulating film 202 may be disposed on the first semiconductor layer 210. The first gate insulating film 202 may be provided to secure insulation between the first semiconductor layer 210 and a first gate layer 220 to be described below. The first gate insulating film 202 may include an inorganic material, such as a silicon oxide, a silicon nitride, a silicon oxynitride, and/or the like, and may be provided between the first semiconductor layer 210 and the first gate layer 220 to be described below. Furthermore, the first gate insulating film 202 may be formed to correspond to the entire surface of the substrate 100, and may have a structure in which contact holes are formed in preset portions. As such, an insulating film including an inorganic material may be formed through chemical vapor deposition (CVD) or atomic layer deposition (ALD). This is the same as embodiments described below and modifications thereof.

The first gate layer 220 may be disposed on a gate insulating film 202. The first gate layer 220 may be located at a position vertically overlapping the first semiconductor layer 210, and may include at least one metal of molybdenum (Mo), aluminum (Al), platinum (Pt), palladium (Pd), silver (Ag), magnesium (Mg), gold (Au), nickel (Ni), neodymium (Nd), iridium (Ir), chromium (Cr), lithium (Li), calcium (Ca), titanium (Ti), tungsten (W), and copper (Cu).

A first interlayer insulating film 203 may be disposed on the first gate layer 220. The first interlayer insulating film 203 may cover the first gate layer 220. The first interlayer insulating film 203 may include an inorganic material. For example, the first interlayer insulating film 203 may be a metal oxide or a metal nitride, and specifically, the inorganic material may include a silicon oxide SiO₂, a silicon nitride SiNₓ, a silicon oxynitride SiON, an aluminum oxide Al₂O₃, a titanium oxide TiO₂, a tantalum oxide Ta₂O₅, a hafnium oxide HfO₂, a zinc oxide ZrO₂, or the like. The first interlayer insulating film 203 may have, in some embodiments, a double structure of SiOₓ/SiN_{y} or SiNₓ/SiO_{y}.

A second gate layer 230 may be disposed on the first interlayer insulating film 203. In some cases, the second gate layer 230 may be omitted. The second gate layer 230 may be located at a position vertically overlapping the first gate layer 220.

The second gate layer 230 may include at least one metal of Mo, Al, Pt, Pd, Ag, Mg, Au, Ni, Nd, Ir, Cr, Li, Ca, Ti, W, and Cu.

In some cases, the second gate layer 230 and the first gate layer 220 may form a storage capacitor. The first gate layer 220 may include a first electrode of the storage capacitor, and the second gate layer 230 may include a second electrode of the storage capacitor.

A second interlayer insulating film 204 may be disposed on the second gate layer 230. The second interlayer insulating film 204 may cover the second gate layer 230. The second interlayer insulating film 204 may include an inorganic material. For example, the second interlayer insulating film 204 may be a metal oxide or a metal nitride, and specifically, the inorganic material may include a silicon oxide SiO₂, a silicon nitride SiNₓ, a silicon oxynitride SiON, an aluminum oxide Al₂O₃, a titanium oxide TiO₂, a tantalum oxide Ta₂O₅, a hafnium oxide HfO₂, a zinc oxide ZrO₂, or the like. The second interlayer insulating film 204 may have, in some embodiments, a double structure of SiOₓ/SiN_{y} or SiNₓ/SiO_{y}.

A second semiconductor layer 240 may be disposed on the second interlayer insulating film 204. The second semiconductor layer 240 may include polysilicon or a silicon oxide. The second semiconductor layer 240 may include a channel region in which impurities are not doped, and a source region and a drain region arranged at opposite sides of the channel region, and in which impurities are doped. The impurities differ from each other depending on the type of thin film transistor, and may include N-type impurities or P-type impurities.

A second gate insulating film 205 may be disposed on the second semiconductor layer 240. The second gate insulating film 205 may be provided to secure insulation between the second semiconductor layer 240 and a gate interlayer to be described below. The second gate insulating film 205 may include an inorganic material, such as a silicon oxide, a silicon nitride, a silicon oxynitride, and/or the like, and may be provided between the second semiconductor layer 240 and a third gate layer 250 to be described below. Furthermore, the second gate insulating film 205 may be formed to correspond to the entire surface of the substrate 100, and may have a structure in which contact holes are formed in preset portions. As such, the insulating film including an inorganic material may be formed through CVD or ALD. This is the same as embodiments described below and modifications thereof.

The third gate layer 250 may be disposed on the second gate insulating film 205. The third gate layer 250 may be disposed at a position vertically overlapping the second semiconductor layer 240, and may include at least one metal of Mo, Al, Pt, Pd, Ag, Mg, Au, Ni, Nd, Ir, Cr, Li, Ca, Ti, W, and Cu.

A third interlayer insulating film 206 may be disposed on the third gate layer 250. The third interlayer insulating film 206 may cover the third gate layer 250. The third interlayer insulating film 206 may include an inorganic material. For example, the third interlayer insulating film 206 may be a metal oxide or a metal nitride, and specifically, the inorganic material may include a silicon oxide SiO₂, a silicon nitride SiNₓ, a silicon oxynitride SiON, an aluminum oxide Al₂O₃, a titanium oxide TiO₂, a tantalum oxide Ta₂O₅, a hafnium oxide HfO₂, a zinc oxide ZrO₂, or the like. The third interlayer insulating film 206 may have, in some embodiments, a double structure of SiOₓ/SiN_{y} or SiNₓ/SiO_{y}.

A fourth gate layer 260 may be disposed on the third interlayer insulating film 206. In some cases, the fourth gate layer 260 may be omitted.

The fourth gate layer 260 may be located at a position vertically overlapping the third gate layer 250, and may include at least one metal of Mo, Al, Pt, Pd, Ag, Mg, Au, Ni, Nd, Ir, Cr, Li, Ca, Ti, W, and Cu.

In some cases, the fourth gate layer 260 and the third gate layer 250 may form a storage capacitor. The fourth gate layer 260 may include a first electrode of the storage capacitor, and the third gate layer 250 may include a second electrode of the storage capacitor.

A fourth interlayer insulating film 207 may be disposed on the fourth gate layer 260.

The fourth interlayer insulating film 207 may cover the fourth gate layer 260. The fourth interlayer insulating film 207 may include an inorganic material. For example, the fourth interlayer insulating film 207 may be a metal oxide or a metal nitride, and specifically, the inorganic material may include a silicon oxide SiO₂, a silicon nitride SiNₓ, a silicon oxynitride SiON, an aluminum oxide Al₂O₃, a titanium oxide TiO₂, a tantalum oxide Ta₂O₅, a hafnium oxide HfO₂, a zinc oxide ZrO₂, or the like. The fourth interlayer insulating film 207 may have, in some embodiments, a double structure of SiOₓ/SiN_{y} or SiNₓ/SiO_{y}.

A first conductive layer 270 may be disposed on the fourth interlayer insulating film 207. The first conductive layer 270 may function as an electrode that extends through a through-hole in the first gate insulating film 202 to the fourth interlayer insulating film 207 to be connected to the source/drain region of the first semiconductor layer 210.

The first conductive layer 270 may function as an electrode that extends through a through-hole in the second gate insulating film 205 to the fourth interlayer insulating film 207 to be connected to the source/drain region of the second semiconductor layer 240.

The first conductive layer 270 may include one or more metals selected from among Al, Pt, Pd, Ag, Mg, Au, Ni, Nd, Ir, Cr, Li, Ca, Mo, Ti, W, and Cu. For example, the first conductive layer 270 may include a Ti layer, an Al layer, and/or a Cu layer.

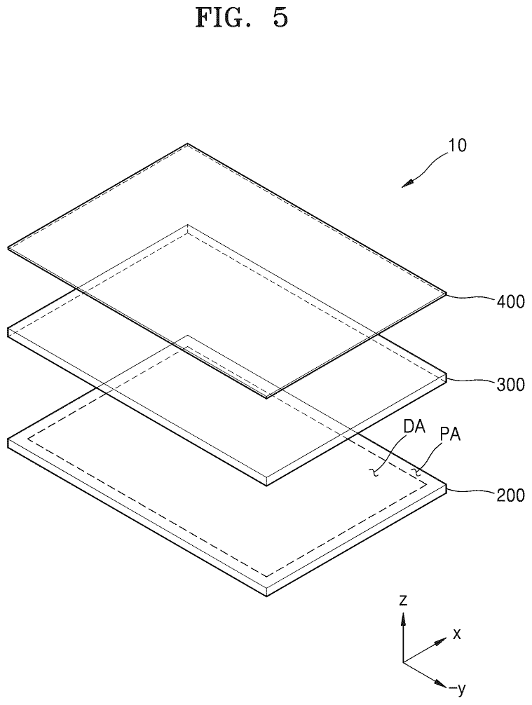

The first conductive layer 270 may form at least parts of data lines or wires to be described below. Furthermore, FIGS. 5 to 14 to be described below may illustrate two-dimensional data lines/wires for convenience of explanation, and the data lines/wires may include the first conductive layer 270.

A first organic insulating layer 208a may be disposed on the first conductive layer 270. The first organic insulating layer 208a may cover the first conductive layer 270 and substantially have a flat upper surface, and may be an organic insulating layer serving as a planarized film. The first organic insulating layer 208a may include an organic material, such as acryl, benzocyclobutene (BCB), hexamethyldisiloxane (HMDSO), or the like. The first organic insulating layer 208a may be variously modified in, for example, a single layer or multilayer and the like.

A second conductive layer 280 may be disposed on the first organic insulating layer 208a. The second conductive layer 280 may serve as an electrode that passes through a through-hole in the first organic insulating layer 208a to be connected to the source/drain region of the first semiconductor layer 210. The second conductive layer 280 may include one or more metals selected from among Al, Pt, Pd, Ag, Mg, Au, Ni, Nd, Ir, Cr, Li, Ca, Mo, Ti, W, and Cu. For example, the second conductive layer 280 may include a Ti layer, an Al layer, and/or a Cu layer.

The first conductive layer 270 and the second conductive layer 280 may form at least parts of data lines or wires to be described below. Furthermore, FIGS. 5 to 14 to be described below may illustrate two-dimensional data lines/wires, for convenience of explanation, and the data lines/wires may include the first conductive layer 270 the second conductive layer 280.

A second organic insulating layer 208b may be disposed on the first conductive layer 270. The second organic insulating layer 208b may cover the first conductive layer 270 and substantially have a flat upper surface, and may be an organic insulating layer serving as a planarized film. The second organic insulating layer 208b may include an organic material, such as acryl, BCB, HMDSO, or the like. The second organic insulating layer 208b may be variously modified in, for example, a single layer or multilayer and the like.

Furthermore, although it is not illustrated in FIG. 4, an additional conductive layer and an additional insulating layer may be provided between the conductive layer and the pixel electrode, and various embodiments thereof may be available. In this state, the additional conductive layer may include the same material as the conductive layer described above, and may have the same layer structure. The additional insulating layer may include the same material as the organic insulating layer described above, and may have the same layer structure.

A pixel electrode 290 may be disposed on the second organic insulating layer 208b. The pixel electrode 290 may be connected to the second conductive layer 280 through a contact hole formed in the second organic insulating layer 208b. A display element may be disposed on the pixel electrode 290. An organic light-emitting diode OLED may be used as the display element. In other words, the organic light-emitting diode OLED may be provided, for example, on the pixel electrode 290. The pixel electrode 290 may include a light-transmissive conductive layer including a light-transmissive conductive oxide, such as ITO, In₂O₃, IZO, or the like, and a reflective layer including a metal, such as Al, Ag, or the like. For example, the pixel electrode 290 may have a three-layer structure of ITO/Ag/ITO.

A pixel defining layer 209 may be disposed on the second organic insulating layer 208b to cover the edge of the pixel electrode 290. In other words, the pixel defining layer 209 may cover the edge of the pixel electrode 290. The pixel defining layer 209 may have an opening portion corresponding to the pixel PX, and the opening portion may be formed to allow at least a central portion of the pixel electrode 290 to be exposed. The pixel defining layer 209 may include an organic material, such as polyimide, HMDSO, or the like.

An intermediate layer 295 and a counter electrode 296 may be located in an opening portion of the pixel defining layer 209. The intermediate layer 295 may include a low molecular weight or polymer material, and when including a low molecular weight material, the intermediate layer 295 may include a hole injection layer, a hole transport layer, an emission layer, an electron transport layer, an electron injection layer, and/or the like. When including a polymer material, the intermediate layer 295 may have a structure including a hole transport layer and an emission layer.

The counter electrode 296 may include a light-transmissive conductive layer formed of a light-transmissive conductive oxide, such as ITO, In₂O₃, IZO, or the like. The pixel electrode 290 is used as an anode, and the counter electrode 296 is used as a cathode. The electrodes may have opposite polarities.

The structure of the intermediate layer 295 is not limited to that of the examples explicitly shown in this disclosure, and may have various structures. For example, at least any one of layers constituting the intermediate layer 295 may be integrally formed with the counter electrode 296. In another embodiment, the intermediate layer 295 may include a layer patterned to correspond to the pixel electrode 290.

The counter electrode 296 may be arranged above the display area DA to cover the entire surface of the display area DA. In other words, the counter electrode 296 may be integrally formed to cover a plurality of pixels. The counter electrode 296 may be electrically connected to a common power supply line (not shown) arranged in the peripheral area PA. In an embodiment, the counter electrode 296 may extend to a barrier wall (not shown).

A cover member 300 may cover the whole of the display area DA and extend toward the peripheral area PA to cover at least a part of the peripheral area PA. The cover member 300 may be a thin film encapsulation layer or a layer formed of a rigid member (e.g., glass, etc.).

When the cover member 300 is a thin film encapsulation layer, the thin film encapsulation layer may include a first inorganic encapsulation layer (not shown), a second inorganic encapsulation layer (not shown), and an organic encapsulation layer (not shown) therebetween. The first inorganic encapsulation layer and the second inorganic encapsulation layer may each include one or more inorganic materials, such as an aluminum oxide, a titanium oxide, a tantalum oxide, a hafnium oxide, a zinc oxide, a silicon oxide, a silicon nitride, a silicon oxynitride, and the like.

The first inorganic encapsulation layer and the second inorganic encapsulation layer may each be a single layer or multilayer including the material described above. The first inorganic encapsulation layer and the second inorganic encapsulation layer may each include the same material or different materials. The thicknesses of the first inorganic encapsulation layer and the second inorganic encapsulation layer may be different from each other. The thickness of the first inorganic encapsulation layer may be greater than the thickness of the second inorganic encapsulation layer. Alternatively, the thickness of the second inorganic encapsulation layer may be greater than the thickness of the first inorganic encapsulation layer, or the thicknesses of the first inorganic encapsulation layer and the second inorganic encapsulation layer may be identical to each other.

The organic encapsulation layer may include a monomer-based material or a polymer-based material. The polymer-based material may include acrylic resin, epoxy-based resin, polyimide, polyethylene, and the like. In an embodiment, the organic encapsulation layer may include acrylate.

As illustrated in FIG. 4, a first-1 thin film transistor TFT1-1 and a first-2 thin film transistor TFT1-2 for implementing the pixel circuit in the display area DA may be arranged. The first-1 thin film transistor TFT1-1 may refer to a transistor structure configured mainly by the first semiconductor layer 210, and the first-2 thin film transistor TFT1-2 may refer to a transistor structure configured mainly by the second semiconductor layer 240.

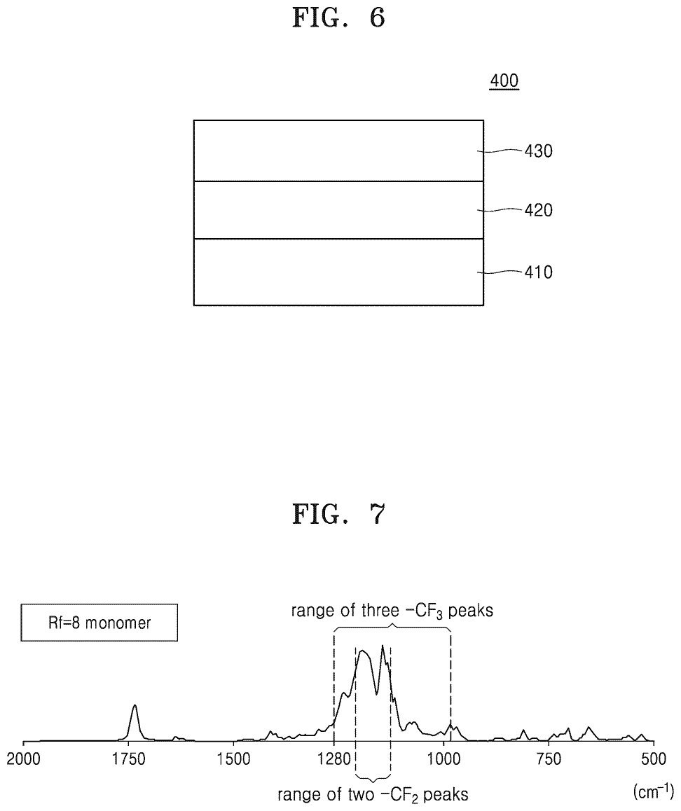

FIG. 5 is a schematic exploded perspective view of a display module 200, a cover member 300, and a protective film 400 of the display device of FIG. 1. FIG. 6 is a conceptual view schematically illustrating a stack structure of the protective film 400 of FIG. 5

For reference, the same or redundant descriptions between FIGS. 5 and 6 and FIGS. 1 to 4 described above may be omitted.

As illustrated in FIG. 5, the display module 200 may include the display area DA and the peripheral area PA. The cover member 300 may be disposed on the display module 200. The protective film 400 may be disposed on the cover member 300.

As illustrated in FIG. 6, the protective film 400 may include a base layer 410, a hard coating layer 420, and a low refractive layer 430. The protective film 400 is transparent, and even when the protective film 400 is disposed as described above, image information displayed in the display area DA may be observed through the protective film 400.

The base layer 410 may be disposed on the cover member 300 of FIG. 5. For example, the base layer 410 may be disposed on the display module 200 of FIGS. 4 and 5. The base layer 410 may be formed of optically transparent and flexible resin. The resin may include at least one type of polyimide-based resin and polyamideimide-based resin. The polyimide-based resin and the polyamideimide-based resin may each be manufactured by a typical method that is well known to a person skilled in the art. The base layer 410 may support the protective film 400 to increase mechanical strength of the protective film 400.

For example, the base layer 410 may be a film of a single layer. However, in some cases, the base layer 410 may have a stack structure in which two homogeneous or heterogeneous resin films are stacked on top of each other and attached with a pressure-sensitive adhesive layer, an adhesive layer, or a pressure-sensitive/adhesive layer interposed therebetween.

The hard coating layer 420 may be disposed on the base layer 410. The hard coating layer 420 may include a composition for the hard coating layer 420 including at least one type of acrylic resin and a solvent. The composition for the hard coating layer 420 may further include at least one type of a crosslinking agent and an initiator. For example, the hard coating layer 420 may have a low refractive index, compared with the base layer 410. For example, the lower surface of the hard coating layer 420 may be in direct contact with the upper surface of the base layer 410.

The low refractive layer 430 may be disposed on the hard coating layer 420. For example, the lower surface of the low refractive layer 430 may be in direct contact with the upper surface of the hard coating layer 420. For example, the low refractive layer 430 may include a monomer.

The low refractive layer 430 may include dodecafluoroheptyl acrylate (C₁₀H₆F₁₂O₂, hereinafter “DFHA”). For example, the low refractive layer 430 may include DFHA only. The low refractive layer 430 including DFHA only may have an effect of allowing to have desired physical properties according to film forming conditions.

For example, n of DFHA may be any one of 6, 8, 10, and 12. For example, n of DFHA may be about 6 to about 12. When n of DFHA is less than 6, there may be an adverse effect on the strength of the protective film 400 or the low refractive layer 430, and when n of DFHA is greater than 6, there may be an adverse effect on deposition efficiency in a vacuum deposition polymerization process. In particular, the low refractive layer 430 may be a monomer in which n of DFHA is 8.

In this present specification, n of DFHA is defined as a degree of polymerization. The term “degree of polymerization” refers to the number of repeating units or monomeric units that constitute the polymer. The degree of polymerization may be described as n. For example, low refractive layer 430 may include a polymer compound consisting of the DFHA, a degree of polymerization of the polymer compound may be any one of 6, 8, 10, and 12. For example, low refractive layer 430 may include a polymer compound consisting of the DFHA, a degree of polymerization of the polymer compound may be 8.

For example, the thickness of the low refractive layer 430 may be about 70 nm to about 130 nm, in particular about 90 nm to about 100 nm.

When the thickness of the low refractive layer 430 is less than 70 nm, there may be an adverse effect on the abrasion resistance and hardness of the protective film 400, and when the thickness of the low refractive layer 430 is greater than 130 nm, there may be an adverse effect on the transparency of the protective film 400. Furthermore, when the thickness of the low refractive layer 430 is about 90 nm to about 100 nm, the protective film 400 may have sufficient transparency while having sufficient abrasion resistance and hardness.

For example, the thickness of the base layer 410 may be about 50 μm to about 150 μm. The thickness of the base layer 410 may be greater than the thickness of the low refractive layer 430 and the thickness of the hard coating layer 420.

For example, the thickness of the hard coating layer 420 may be about 1 μm to about 25 μm. The thickness of the hard coating layer 420 may be greater than the thickness of the low refractive layer 430 and less than the thickness of the base layer 410.

The thickness of the base layer 410 may be the greatest of the layers constituting the protective film 400, and the thickness of the hard coating layer 420 may be greater than the thickness of the low refractive layer 430. As the thickness of the hard coating layer 420 is greater than the thickness of the low refractive layer 430, the overall hardness of the protective film 400 may be improved.

For example, the fluorine content of the low refractive layer 430 may be about 45 wt % to about 80 wt %. When the fluorine content of the low refractive layer 430 is less than 45 wt % or greater than 80 wt %, there may be an adverse effect on reflectance and a contact angle (in particular, an initial contact angle).

In the present specification, the term “contact angle (°)” can be defined as the angle formed between the liquid-gas interface and the liquid-solid interface when a liquid droplet is positioned on a solid surface.

FIG. 7 is a graph showing result data of performing RAS-IR analysis on the low refractive layer 430 of FIG. 6.

For reference, the same or redundant descriptions between FIG. 7 and FIGS. 1 to 6 described above may be omitted.

As illustrated in FIG. 7, result data of performing RAS-IR analysis on the low refractive layer 430 of FIG. 4 may be an infrared absorption spectrum of the low refractive layer 430.

In the graph of FIG. 7, the horizontal axis denotes a wavenumber (cm⁻¹), and the vertical axis denotes a normalized size in which the maximum value may be 1. As the graph shows a normalized size, for convenience of explanation, the vertical axis may be omitted in in FIG. 7.

For example, the infrared spectrum of the low refractive layer 430 may include two —CF₂ peaks and three —CF₃ peaks. The —CF₂ peaks may have one peak frequency in a range of about 1150 cm⁻¹ to about 1160 cm¹, and one peak frequency in a range of about 1210 cm⁻¹ to about 1220 cm⁻¹. The —CF₃ peaks may have three peak frequencies in a range of about 975 cm⁻¹ to about 1280 cm⁻¹, and specifically, the —CF₃ peaks may be frequencies of about 981 cm⁻¹, about 1159 cm⁻¹, and about 1278 cm⁻¹.

Table 1 below shows both-side reflectance (%) and crack strain (%) for each thickness of the low refractive layer 430 including a monomer in which n of DFHA is 8.

TABLE 1

| | Base | Base layer/Hard coating layer/ | | |
|---|---|---|---|---|
| | layer/Hard | Low refractive layer thickness | | |
| | coating layer | 250 nm | 200 nm | 90 nm |
| Reflectance | 8.84 | 6.62 | 5.72 | 5.35 |
| (@550 nm) | | | | |
| Crack strain | 8.36 | — | — | 8.2 |

However, it is assumed that the remaining characteristics other than the thickness of the low refractive layer 430 remain unchanged.

The both-side reflectance (%) may refer to a reflectance measured in a transmissive mode of a reflectance measurement apparatus, and the both-side reflectance (%) may be converted into a reflectance measured in a reflective mode of the reflectance measurement apparatus.

According to Table 1, a reflectance measured when the thickness of the low refractive layer 430 is 250 nm is greater than a reflectance measured when the thickness of the low refractive layer 430 is 200 nm. Furthermore, the reflectance measured when the thickness of the low refractive layer 430 is 200 nm is greater than a reflectance measured when the thickness of the low refractive layer 430 is 90 nm.

The reflectance measured when the thickness of the low refractive layer 430 is 90 nm is 5.35, which amounts to about 1.35 when converted into a reflectance measured in a reflective mode. Accordingly, when the thickness of the low refractive layer 430 is 90 nm, the protective film 400 having a low reflectance (e.g., a reflectance target value is 2% or less) may be provided.

According to Table 1, when the thickness of the low refractive layer 430 is 90 nm, it is confirmed that there is little difference between before and after the low refractive layer 430 is attached.

Table 2 below shows a contact angle of the low refractive layer 430 including a monomer in which n of DFHA is 8.

TABLE 2

| Base layer/Hard | Base layer/Hard coating | | |
|---|---|---|---|
| coating layer | layer/Low refractive layer | | |
| Initial contact angle | | Eraser 1K | Eraser 3K |
| 80.7° | 111.2° | 97.6° | 85.4° |

The term “Eraser” in [table 2] may refer to “Eraser test” conducted under pre-determined conditions, and the term “K” in [table 2] may mean 1,000 cycles of reciprocal movement. The eraser test is a type of abrasion resistance test performed on the surface of the target. It can be carried out by pressing an industrial eraser against the surface and then moving the eraser side to side. The predetermined conditions in eraser test may include the amount of force applied to the surface of the target, the number of side-to-side movements, and the specifications of the industrial eraser.

However, it is assumed that the remaining characteristics of the protective film 400 other than the inclusion of the low refractive layer 430 remain unchanged. The low refractive layer 430 of Table 2 has a thickness of 90 nm, and the refractive index of the low refractive layer 430 may be 1.342.

The initial contact angle of the protective film 400 including the low refractive layer 430 according to an embodiment is 111.2°, and the protective film 400 including the low refractive layer 430 has more improved water repellency than a protective film that does not include the low refractive layer 430.

Referring to FIGS. 5 to 7, the protective film 400 described above included in a display device according to an embodiment may have the following characteristics and effects.
(1) a reflectance (@550 nm) of about 0.5 to about 2.0, in particular about 1.0 to about 1.5
(2) a crack strain of about 6% to about 15%, in particular about 8% to about 12%
(3) an initial contact angle (water) of 100° or more

In detail, when the reflectance (@550 nm) of the low refractive layer 430 is less than 0.5 or greater than 2.0, there is an adverse effect on the display quality by external light.

In detail, when the crack strain of the low refractive layer 430 is less than 6%, when implementing a flexible display device, the protective film 400 or the low refractive layer 430 may be damaged by a folding operation. When the crack strain of the low refractive layer 430 is less than 10%, when implementing a flexible display device, there is an adverse effect on the stability or reliability of the protective film 400 or the low refractive layer 430.

In detail, when the initial contact angle (water) of the low refractive layer 430 is less than 100°, it may be difficult to protect the display module 200 or the display panel 10 from moisture.

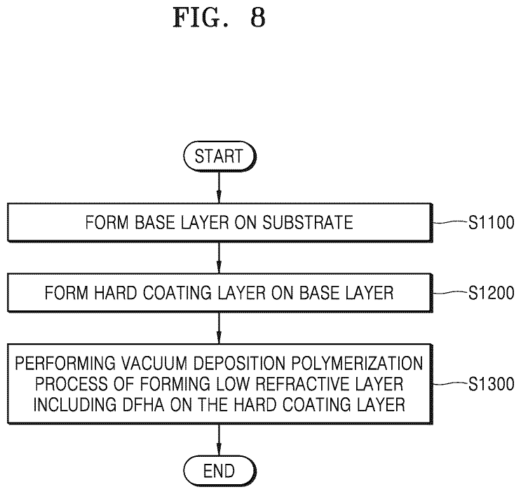

FIG. 8 is a flowchart schematically showing a method of manufacturing the protective film, according to an embodiment.

For reference, the same or redundant descriptions between FIG. 8 and FIGS. 1 to 7 described above may be omitted.

As illustrated in FIG. 8, a method of manufacturing the protective film 400 may include: forming the base layer 410 on a substrate (S1100); forming the hard coating layer 420 on the base layer 410 (S1200); and performing a vacuum deposition polymerization process of forming the low refractive layer 430 including DFHA on the hard coating layer 420 (S1300).

The vacuum deposition polymerization process may be performed in a first condition and a second condition, and the first condition may mean that a substrate temperature is −20° C. and the second condition may mean that an ion acceleration voltage is 100 V. Like the first condition and the second condition, the substrate temperature and the ion acceleration voltage may be included in the film forming conditions.

Table 3 shows the ingredient contents of the low refractive index layers 430 measured using XPS analysis.

TABLE 3

| Embodiments | | C [%] | O [%] | F [%] | F/C | O/C | F/O |
|---|---|---|---|---|---|---|---|
| Comparative | Rf8(C₁₃H₇F₁₇O₂) | 40.63 | 6.25 | 53.13 | 1.31 | 0.15 | 8.50 |
| Example | monomer layer | | | | | | |
| Embodiment | Low refractive layer | 44.93 | 5.75 | 49.32 | 1.10 | 0.13 | 8.58 |
| A | (100 V film forming) | | | | | | |
| Embodiment | Low refractive layer | 49.46 | 4.65 | 45.89 | 0.93 | 0.09 | 9.87 |
| B | (500 V film forming) | | | | | | |

### (all Substrate Temperatures are −20° C.)

A monomer layer in which n of DFHA is 8 and which does not use an ion acceleration voltage is a comparative example of which ingredient content is as above.

In Embodiment A, the low refractive layer 430 is formed by a vacuum deposition polymerization process wherein an ion acceleration voltage of 100 V is applied to a monomer in which n of DFHA is 8. In Embodiment B, the low refractive layer 430 is formed by a vacuum deposition polymerization process in which an ion acceleration voltage 500 V is applied to to a monomer in which n of DFHA is 8.

It is observed that the fluorine contents of Embodiment A and Embodiment B are lower than the fluorine content of a comparative example. In detail, the fluorine content of Embodiment A is less than the fluorine content of the comparative example, and the fluorine content of Embodiment B is lower than the fluorine content of Embodiment A.

The above trend in the fluorine content may be due to the breakdown of fluorine bonds as the ion acceleration voltage increases. Accordingly, in the film forming conditions, the fluorine content decreases as the ion acceleration voltage increases.

As for oxygen content, it is observed that the oxygen contents of Embodiment A and Embodiment B are lower than the oxygen content of the comparative example. In detail, the oxygen content of Embodiment A is lower than the oxygen content of the comparative example, and the oxygen content of Embodiment B is lower than the oxygen content of Embodiment A.

As for carbon content, it is observed that the carbon contents of Embodiment A and Embodiment B are higher than the carbon content of the comparative example. In detail, the carbon content of Embodiment A is greater than the carbon content of the comparative example, and the carbon content of Embodiment B is greater than the carbon content of Embodiment A.

According to Table 3, the fluorine content of the low refractive layer 430 is higher under the film forming condition of 100 V than under the film forming condition of 300 V. The higher the fluorine content, the lower the surface energy of the low refractive layer 430, and as a result, the initial contact angle increases as indicated in Table 4 described below.

Accordingly, in summarizing Table 3, the low refractive layer 430 according to an embodiment may have the following characteristics.
(1) The fluorine content of the low refractive layer 430 is about 45 wt % to about 80 wt %.
(2) The fluorine content/carbon content of the low refractive layer 430 is about 1 to about 1.5.
(3) The oxygen content/carbon content of the low refractive layer 430 is about 0.1 to about 0.5.
(4) The fluorine content/oxygen content of the low refractive layer 430 is about 6 to about 8.6.

Table 4 below shows reflectance and contact angle evaluation results according to the film forming conditions.

TABLE 4

| | | | Post- | | | | |
|---|---|---|---|---|---|---|---|
| | | Pre- | treatment | | Contact angle (°) | | |
| | | treatment | (150° C., | Reflectance | | Scuff | Eraser |
| Conditions | | (UV ozone) | 30 min) | (%) | Initial | 1K | 3K |
| Embodiment | 100 V | None | None | 4.66 | 114.7 | 82.1 | 102.3 |
| 1 | | | | | | | |
| Embodiment | 100 V | None | Present | 4.88 | 121.4 | 74.7 | 99.2 |
| 2 | | | | | | | |
| Embodiment | 100 V | Present | None | 5.85 | 89.0 | 52.8 | 72.8 |
| 3 | (No monomer | | | | | | |
| | boat heating) | | | | | | |
| Embodiment | 100 V | Present | None | 5.47 | 82.7 | 65.9 | 85.6 |
| 4 | (Monomer | | | | | | |
| | boat heating) | | | | | | |
| Embodiment | 100 V | Present | Present | 6.26 | 116.5 | 65.5 | 88.6 |
| 5 | | | | | | | |
| Embodiment | 100 V | Present | None | 6.42 | 110.1 | 72.5 | 99.6 |
| 6 | | | | | | | |
| Embodiment | 300 V | Present | Present | 6.05 | 113.5 | 80.3 | 97.5 |
| 7 | | | | | | | |
| Embodiment | 300 V | Present | None | 4.62 | 115.6 | 82.1 | 88.3 |
| 8 | | | | | | | |

(All substrate temperatures are −20° C.)

The term “Scuff” in [table 4] above may refers to “Scuff test” conducted under pre-determined conditions, the term “Eraser” in [table 4] may refer to “Eraser test” conducted under pre-determined conditions, and the term “K” in [table 4] may mean 1,000 cycles of reciprocal movement. The scuff test can be conducted by pressing a hard object against the surface of the target and then moving the hard object side to side. The term “hard object” may refer to items made of metal, such as rods or spheres. The predetermined conditions in the scuff and eraser tests may include the amount of force applied to the surface of the target, the number of side-to-side movements and the material of the hard object.

In Embodiments 1 to 8, the low refractive layers 430 have the same thickness, which are formed by performing a vacuum deposition polymerization process on DFHA having n of 8. Various conditions applied to Embodiments 1 to 8 may further include conditions other than the conditions shown in Table 4.

Table 4 shows a summary of reflectance and contact angle data of various embodiments according to the size of an ion acceleration voltage, whether a pre-treatment is performed, whether a post-treatment is performed, and the like.

The pre-treatment process may be a UV ozone processing process performed at room temperature. Oxygen molecules in the atmosphere are dissolved by the UV ozone processing process. As a result, ozone is generated, and thus, an organic material on the upper surface of the hard coating layer 420 may be removed by the generated ozone. In the UV ozone processing process used herein, a UV irradiation distance and a UV irradiation time may be about 10 mm to about 100 mm and about 0 min to about 15 min, respectively. For example, when the UV irradiation distance is 10 mm and the UV irradiation time is 15 min, the contact angle of the low refractive layer 430 may be 13.33°. In other words, when the UV irradiation distance is 10 mm and the UV irradiation time is 15 min, the contact angle of the low refractive layer 430 may be the smallest.

The post-treatment process may be a baking process of heating the low refractive layer 430 formed through the vacuum deposition polymerization process at 150° C. for 30 min. In other words, the post-treatment process may be a baking process of heating the low refractive layer 430 at 150° C. for 30 min in a chamber after deposition polymerization.

The ion acceleration voltage applied to the manufacturing method of Embodiments 1 and 2 is 100 V, and the manufacturing method of Embodiments 1 and 2 do not include the pre-treatment process. In this state, Embodiment 1 relates to the low refractive layer 430 to which the post-treatment process is applied, and Embodiment 2 relates to the low refractive layer 430 to which the post-treatment process is not applied. It is configured that a difference in reflectance and contact angle between Embodiments 1 and 2 is insignificant.

The ion acceleration voltage applied to the manufacturing method of Embodiment 3 is 100 V, and the manufacturing method of Embodiment 3 includes the pre-treatment process described above. It is confirmed that the reflectance of Embodiment 3 is higher than the reflectance of Embodiment 1, and that the contact angle of Embodiment 3 is less than the contact angle of Embodiment 1.

The ion acceleration voltage applied to the manufacturing method of Embodiment 4 is 100 V, and the manufacturing method of Embodiment 4 includes the pre-treatment process described above. However, the manufacturing method of Embodiment 4, unlike the manufacturing method of Embodiment 3, may further include a condition of heating a monomer boat at about 10° C. to about 90° C. when performing the vacuum deposition polymerization process. The heating temperature of a monomer boat may be in particular about 40° C. to about 50° C.

As a result, it is confirmed that the reflectance of Embodiment 3 is less than that of Embodiment 4, and the initial contact angle of Embodiment 3 is less than the initial contact angle of Embodiment 4, but that the Scuff characteristics and eraser characteristics of Embodiment 3 is improved compared with the Scuff characteristics and eraser characteristics of Embodiment 4. The Scuff characteristic refers to the contact angle after the Scuff test, and the Eraser characteristic can refer to the contact angle after the Eraser test. In this case, an improvement in the Scuff characteristic and the Eraser characteristic may indicate that the magnitude of the contact angle has decreased.

The ion acceleration voltage applied to the manufacturing methods of Embodiments 5 and 6 is 100 V, and the manufacturing methods of Embodiments 5 and 6 include the pre-treatment process. In this state, Embodiment 5 relates to the low refractive layer 430 to which the post-treatment process is applied, and Embodiment 6 relates to the low refractive layer 430 to which the post-treatment process is not applied. It is confirmed that a difference in reflectance and contact angle between Embodiment 5 and Embodiment 6 is insignificant.

However, the reflectance of Embodiment 5 is greater than the reflectance of Embodiment 3, and that the contact angle of Embodiment 5 is also greater than the contact angle of Embodiment 3. The difference between Embodiments 5 and 3 lies in whether the post-treatment process is performed.

The ion acceleration voltage applied to the manufacturing methods of Embodiments 7 and 8 is 300 V, and the manufacturing methods of Embodiments 7 and 8 include the pre-treatment process. In this state, Embodiment 7 relates to the low refractive layer 430 to which the post-treatment process is applied, and Embodiment 8 relates to the low refractive layer 430 to which the post-treatment process is not applied. It is confirmed that the reflectance of Embodiment 7 increases, compared with the reflectance of Embodiment 8. It is confirmed that a difference between the contact angle of Embodiment 7 and the contact angle of Embodiment 8 is insignificant.

As a result, according to Tables 3 and 4, in the method of manufacturing the protective film 400, according to an embodiment, the characteristics of the vacuum deposition polymerization process may be as follows.
(1) The ion acceleration voltage being about 80 V to about 120 V, in particular 100 V.
(2) Performing the pre-treatment process before the vacuum deposition polymerization process.
(3) Performing the post-treatment process after the vacuum deposition polymerization process.

As the method of manufacturing the protective film 400, according to an embodiment, includes the above three characteristics, there may be a remarkable effect of having a high reflectance and a high contact angle (in particular, an initial contact angle) of the embodiments of Tables 3 and 4.

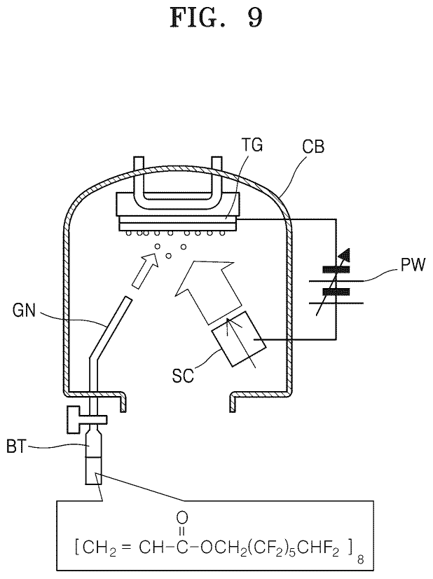

FIG. 9 is a conceptual view of a process used in the manufacturing method of FIG. 8.

For reference, the same or redundant descriptions between FIG. 9 and FIGS. 1 to 8 described above may be omitted.

As illustrated in FIG. 9, the vacuum deposition polymerization process of the manufacturing method of FIG. 8 may be a dry deposition method performed within a chamber CB. The DFHA described above may be ejected from a monomer storage container BT through a monomer nozzle GN, and argon molecules Ar₂ may be ejected from an ion source SC. The ion source SC may receive necessary power from a voltage generator PW, and the DFHA described above may be deposited on a target TG such as a substrate and the like.

According to an embodiment described above, a protective film having low reflectance and being resistant to cracks, a display device including the same, and a method of manufacturing the protective film may be implemented. The scope of the disclosure is not limited by the above effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A protective film comprising:
a base layer;
a hard coating layer disposed on the base layer; and
a low refractive layer disposed on the hard coating layer and including dodecafluoroheptyl acrylate (DFHA).

2. The protective film of claim 1, wherein the low refractive layer includes a polymer compound consisting of the DFHA, a degree of polymerization of the polymer compound is any one of 6, 8, 10, and 12.

3. The protective film of claim 1, wherein the low refractive layer includes a polymer compound consisting of the DFHA, a degree of polymerization of the polymer compound is 8.

4. The protective film of claim 1, wherein the low refractive layer includes the DFHA only.

5. The protective film of claim 1, wherein a thickness of the low refractive layer is about 70 nm to about 130 nm.

6. The protective film of claim 1, wherein a fluorine content of the low refractive layer is about 45 wt % to about 80 wt %.

7. The protective film of claim 1, wherein an infrared spectrum of the low refractive layer includes two —CF₂ peaks and three —CF₃ peaks.

8. The protective film of claim 7, wherein the —CF₂ peaks include a first peak frequency in a range of about 1150 cm⁻¹ to about 1160 cm⁻¹ and a second peak frequency in a range of about 1210 cm⁻¹ to about 1220 cm⁻¹.

9. The protective film of claim 8, wherein the —CF₃ peak has three peak frequencies in a range of about 975 cm⁻¹ to about 1280 cm⁻¹.

10. A display device comprising:
a display module foldable with respect to at least one folding axis; and
a protective film disposed on the display module,
wherein the protective film comprises:
a base layer;
a hard coating layer disposed on the base layer; and
a low refractive layer disposed on the first coating layer and including dodecafluoroheptyl acrylate (DFHA).

11. The display device of claim 10, wherein the low refractive layer includes a polymer compound consisting of the DFHA, a degree of polymerization of the polymer compound is any one of 6, 8, 10, and 12.

12. The display device of claim 10, wherein the low refractive layer includes a polymer compound consisting of the DFHA, a degree of polymerization of the polymer compound is 8.

13. The display device of claim 10, wherein the low refractive layer includes the DFHA only.

14. The display device of claim 10, wherein a thickness of the low refractive layer is about 70 nm to about 130 nm.

15. The display device of claim 10, wherein a fluorine content of the low refractive layer is about 45 wt % to about 80 wt %.

16. The display device of claim 10, wherein an infrared spectrum of the low refractive layer includes two —CF₂ peaks and three —CF₃ peaks.

17. The display device of claim 16, wherein the —CF₂ peaks include a first peak frequency in a range of about 1150 cm⁻¹ to about 1160 cm⁻¹ and a second peak frequency in a range of about 1210 cm⁻¹ to about 1220 cm⁻¹.

18. The display device of claim 17, wherein the —CF₃ peak has three peak frequencies in a range of about 975 cm⁻¹ to about 1280 cm⁻¹.

19. A method of manufacturing a protective film, the method comprising:
forming a base layer on a substrate;
forming a hard coating layer on the base layer; and
performing a vacuum deposition polymerization process of forming a low refractive layer including dodecafluoroheptyl acrylate (DFHA) on the hard coating layer.

20. The method of claim 19, further comprising performing an ultraviolet (UV) ozone processing process on an upper surface of the hard coating layer before the performing of the vacuum deposition polymerization process.
